(19) United States
(12) Patent Application Publication
(10) Pub. No.: US 2014/0176995 A1
(43) Pub. Date: Jun. 26, 2014

(54) INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: Jun Nakawaki, Yokohama-shi (JP)

(73) Assignee: CANON KABUSHIKI KAISHA, Tokyo (JP)

(21) Appl. No.: 14/133,473

(22) Filed: Dec. 18, 2013

(30) Foreign Application Priority Data
Dec. 21, 2012 (JP) 2012-280169

(51) Int. Cl. H04N 1/00

(52) U.S. Cl. CPC H04N 1/00962
USPC 358/1.15

(57) ABSTRACT

A plurality of received documents is stored, and a plurality of documents transmitted from the same transmitting source as an identified document is selected from the stored plurality of documents. A screen is then provided which allows information on the plurality of documents that have been selected, to be collectively registered.

### BACKGROUND

1. Field of the Disclosure

Aspects of the present invention generally relate to an information processing system, an information processing method for registering information on a received document, and a storage medium.

2. Description of the Related Art

Patent offices and law offices (hereinafter referred to as offices) charge clients for cost incurred in work performed for the clients. The office often charges the client for each case requested from the client. Such cases include a contract to be made between companies, and a lawsuit in which a company is a plaintiff or a defendant.

The office separately manages the cost for each case to charge the client for each case. The cost includes labor costs for performing the work, the costs of paper consumed in performing copying and printing, and communication expenses for performing facsimile transmission and reception.

When the cost is managed for each case as described above, it is particularly burdensome to register the cost for performing facsimile reception. Conventionally, the cost for performing facsimile reception is registered as follows. A user calculates reception cost based on the number of sheets in a facsimile-received document, and identifies the case the facsimile-received document is related to. The user then calculates the labor cost incurred in performing the above-described work.

Japanese Patent Application Laid-Open No. 2001-282814 discusses a system which sets as an initial value an attribute that the user has last input to an attribute input screen when the user sorts the facsimile document. Further, the facsimile-received document is automatically generated into a file and registered in a document management server.

However, Japanese Patent Application Laid-Open No. 2001-282814 does not discuss a method for reducing the load on the user for registering the cost related to facsimile reception and the like. It is thus still necessary for the user to register the cost related to facsimile reception and the like for each facsimile reception, which is burdensome for the user.

### SUMMARY

Aspects of the preset invention relate to providing a method for reducing the load on a user for registering information on the received document.

One aspect of the present invention provides an information processing system including a storing unit configured to store a plurality of received documents, a selection unit configured to select from among the received documents stored in the storing unit a plurality of documents transmitted from the same transmitting source as an identified document, and a providing unit configured to provide a screen which allows information on a plurality of documents selected by the selection unit to be collectively registered.

Further features and aspects of the present invention will become apparent from the following detailed description of exemplary embodiments with reference to the attached drawings.

### BRIEF DESCRIPTION OF THE DRAWINGS

FIG. 1 illustrates an example of a system configuration of an image processing system according to a first exemplary embodiment.

FIG. 2 illustrates an example of a hardware configuration of a multifunction peripheral (MFP).

FIG. 3 illustrates an example of a hardware configuration of a case management server.

FIG. 4 illustrates an example of a facsimile reception management list stored in a hard disk drive (HDD) of the MFP.

FIG. 5 illustrates an example of a case management list stored in the HDD of the case management server.

FIGS. 6A and 6B respectively illustrate first and second examples of a document management list stored in the HDD of the case management server.

FIGS. 7A and 7B respectively illustrate first and second examples of a cost management list stored in the HDD of the case management server.

FIG. 8 is a flowchart illustrating a series of processes performed when the MFP performs facsimile reception.

FIG. 9 illustrates an example of the content of a notification e-mail transmitted in step S810 of the flowchart illustrated in FIG. 8.

FIG. 10, composed of FIG. 10A and FIG. 10B, is a flowchart illustrating a process performed by the MFP when a user confirms the content of the facsimile-received document and registers a case, a type, a file name, and the cost.

FIGS. 11A, 11B, and 11C respectively illustrate first, second, and third examples of an operation screen displayed on a display device of a personal computer (PC).

FIG. 12 illustrates an example of a temporary cost information list.

FIG. 13 illustrates an example of the operation screen displayed on the display device of the PC.

FIG. 14 illustrates an example of a sequence performed in the image processing system.

FIG. 15 illustrates an example of a system configuration of an image processing system according to a second exemplary embodiment of the present invention.

FIG. 16 is a flowchart illustrating a series of processes performed when the MFP performs facsimile reception.

### DESCRIPTION OF THE EMBODIMENTS

Various exemplary embodiments, features, and aspects of the invention will be described in detail below with reference to the drawings.

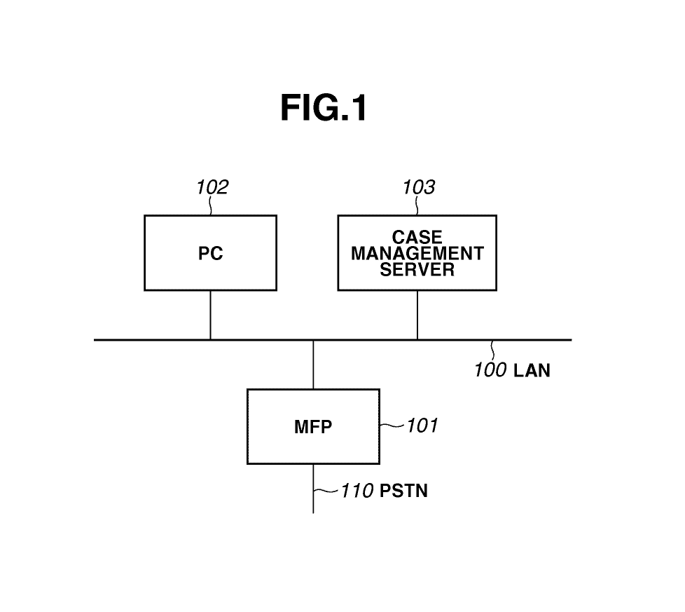

FIG. 1 illustrates an example of a system configuration of an image processing system. Referring to FIG. 1, an MFP 101, a PC 102, and a case management server 103 are connected on a local area network (LAN) 100 to be communicable with each other. The MFP 101 is an example of a facsimile management apparatus, the PC 102 is an example of an information processing apparatus, and the case management server 103 is an example of a server apparatus.

Further, the MFP 101 is connected to a public switched telephone network (PSTN) 110, and is capable of transmitting to and receiving from a facsimile apparatus (not illustrated) a facsimile. Furthermore, the MFP 101 includes a web server. The PC 102 includes a web browser and displays a screen using HyperText Markup Language (HTML) and JavaScript® provided by the web server in the MFP 101. The MFP 101 can thus receive from a user of the PC 102 an operation instruction thereto via the web browser. Moreover, the MFP 101 communicates, using HyperText Transfer Protocol (HTTP)/HTTP Secure (HTTPS), with a web service provided by the case management server 103. FIG. 1 illustrates an example in which the case management server 103 exists on the LAN 100. However, the case management server 103 may exist on the Internet. Further, the case management server 103 may be configured as a cloud server in which a plurality of servers cooperates and performs the processes.

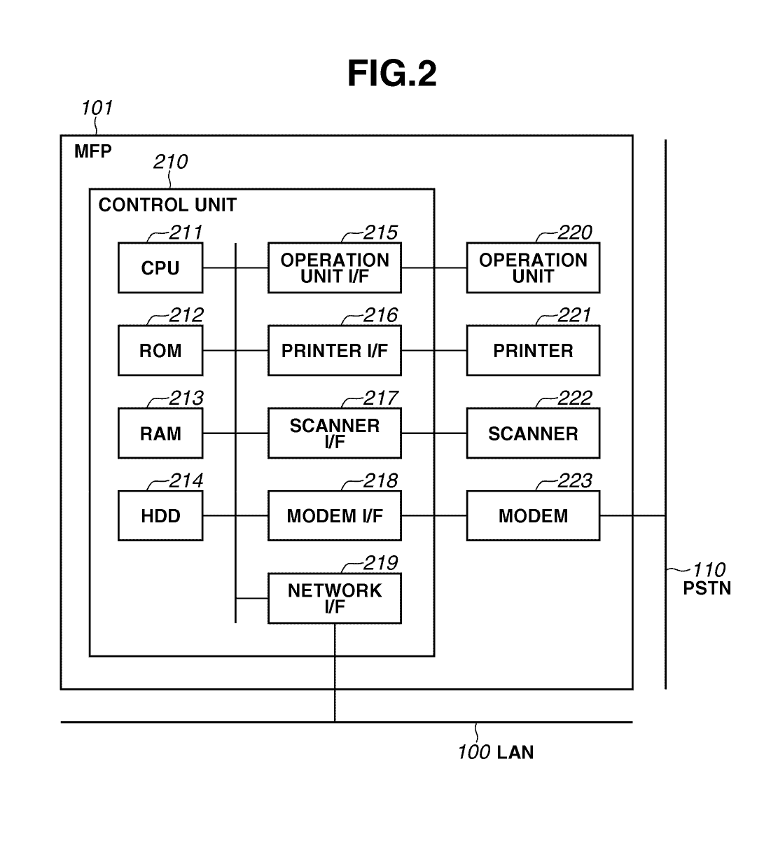

FIG. 2 illustrates an example of a hardware configuration of the MFP 101. Referring to FIG. 2, a control unit 210, including a central processing unit (CPU) 211, controls the operations of the MFP 101. The CPU 211 reads control programs stored in a read-only memory (ROM) 212 and performs various types of control, such as read control and transmission control. A random access memory (RAM) 213 is used as a temporary storage area of a main memory and a work area of the CPU 211. In the case of the MFP 101, one CPU 211 uses one memory (i.e., the RAM 213 or an HDD 214) and performs each of the processes illustrated in the flowcharts to be described below, based on the programs. However, other methods may be used. For example, a plurality of CPUs and a plurality of RAMs or HDDs may cooperate and perform each of the processes illustrated in the flowcharts to be described below, based on the programs.

The HDD 214 stores image data and various programs. An operation unit interface (I/F) 215 connects an operation unit 220 and the control unit 210. The operation unit 220 includes a liquid crystal display unit having a touch panel function, and a keyboard.

A printer I/F 216 connects a printer 221 and the control unit 210. The control unit 210 transfers via the printer I/F 216 the image data to be printed by the printer 221, and the printer 221 prints the image data on a recording medium.

A scanner I/F 217 connects a scanner 222 and the control unit 210. The scanner 222 reads an image on the document and generates the image data (i.e., an image file), and inputs the image data to the control unit 210 via the scanner I/F 217. The MFP 101 is capable of transmitting the image data (i.e., the image file) generated by the scanner 222 by file transfer or by e-mail.

A modem I/F 218 connects a modem 223 and the control unit 210. The modem 223 connects the control unit 210 (i.e., the MFP 101) to the PSTN 110. The modem 223 performs facsimile communication with the facsimile apparatus on the PSTN 110.

A network I/F 219 connects the control unit 210 (i.e., the MFP 101) to the LAN 100. The network I/F 219 transmits to an external device (i.e., the PC 102 and the case management server 103) on the LAN 100 the image data and various types of information, and receives from the external device on the LAN 100 the various types of information.

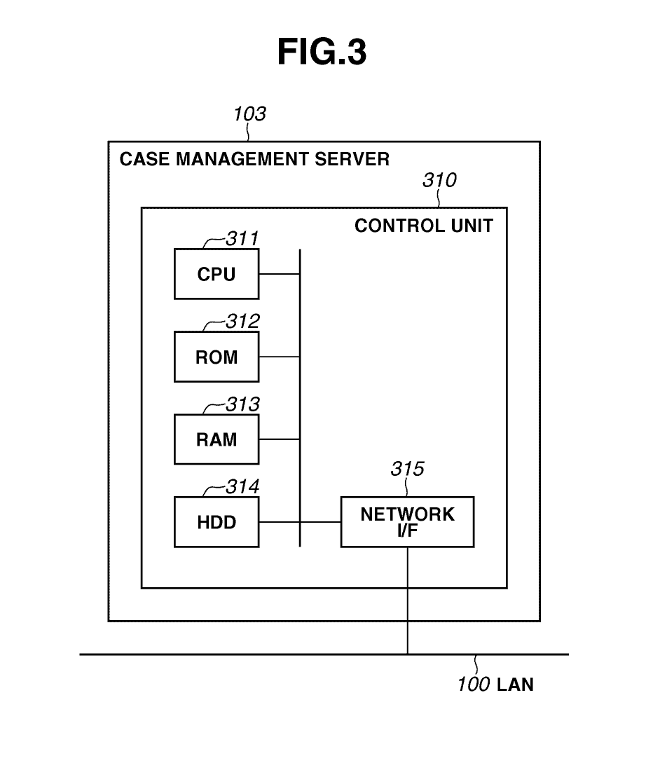

FIG. 3 illustrates an example of a hardware configuration of the case management server 103. Referring to FIG. 3, a control unit 310, including a CPU 311, controls the operations of the case management server 103. The CPU 311 reads the control programs stored in a ROM 312 and performs various control processes. A RAM 313 is used as a temporary storage area of a main memory and a work area of the CPU 311. An HDD 314 stores the image data and various programs.

A network I/F 315 connects the control unit 310 (i.e., the case management server 103) to the LAN 100. The network I/F 315 transmits to and receives from other devices on the LAN 100 various types of information.

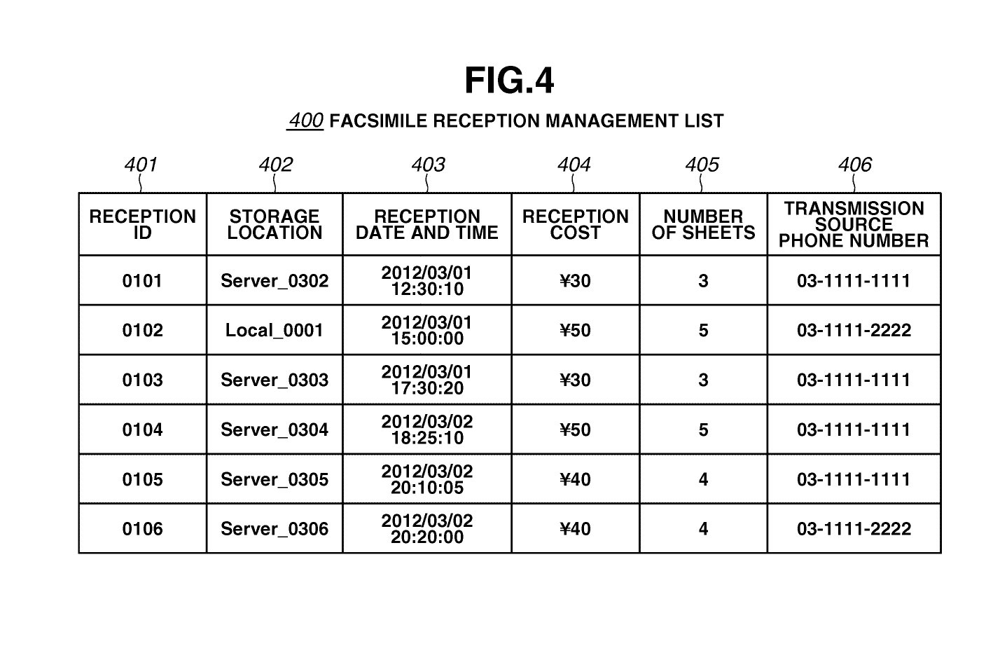

FIG. 4 illustrates an example of a facsimile reception management list 400 stored in the HDD 214 of the MFP 101. Referring to FIG. 4, when the MFP 101 facsimile-receives a document, the MFP 101 adds a new record to the facsimile reception management list 400 and manages the information on the facsimile reception.

In the facsimile reception management list 400, a reception identification (ID) 401 is information which uniquely indicates each facsimile reception, and is an example of identification information for identifying the facsimile reception. A storage location 402 is information indicating a location in which the facsimile-received document is stored and a document ID assigned to the document in the storage location. If the storage location 402 is “Server_{—}0302”, it indicates that the facsimile-received document is stored in (the HDD 314 of) the case management server 103, and managed using the document ID “0302”. Further, if the storage location 402 is “Local_{—}0001”, it indicates that the facsimile-received document is stored in (the HDD 214 of) the MFP 101, and managed using the document ID “0001”.

Reception date and time 403 is information indicating the date and time the document is facsimile-received. A reception cost 404 is information indicating the cost incurred in facsimile-receiving the document. A number of sheets 405 is information indicating the number of sheets of the document which has been facsimile-received. A unit cost (including communication expenses and an apparatus usage fee) incurred in facsimile-receiving one sheet of a document is predetermined in the MFP 101. The reception cost 404 can thus be obtained from the predetermined unit cost and the number of sheets 405. If the MFP 101 is connected to a plurality of telephone lines, different unit costs may be set for each telephone line. A transmission source phone number 406 is information indicating a phone number of a transmission source of the facsimile-received document. Different unit costs may be set for each phone number.

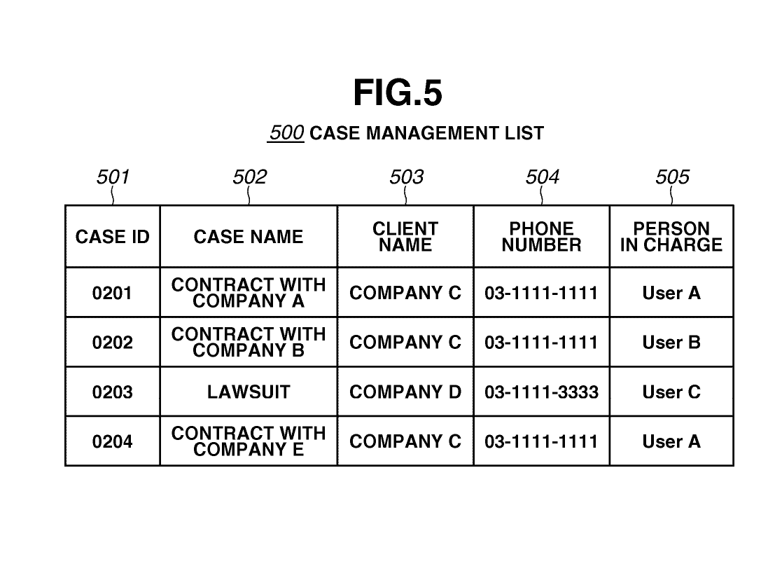

FIG. 5 illustrates an example of a case management list 500 stored in the HDD 314 of the case management server 103. Referring to FIG. 5, when the office in which the MFP 101 is installed receives a new case from the client, the MFP 101 adds a new record to the case management list 500, and manages the information on the case.

A case ID 501 in the case management list 500 is information uniquely indicating each case. A case name 502 is information indicating a name of the case. A client name 503 is information indicating the name of the client (i.e., a company or an individual person) who has requested the case. A phone number 504 is information indicating the telephone number of the client. A person in charge 505 is information indicating a member of the office (i.e., a user of the MFP 101) who is in charge of the case.

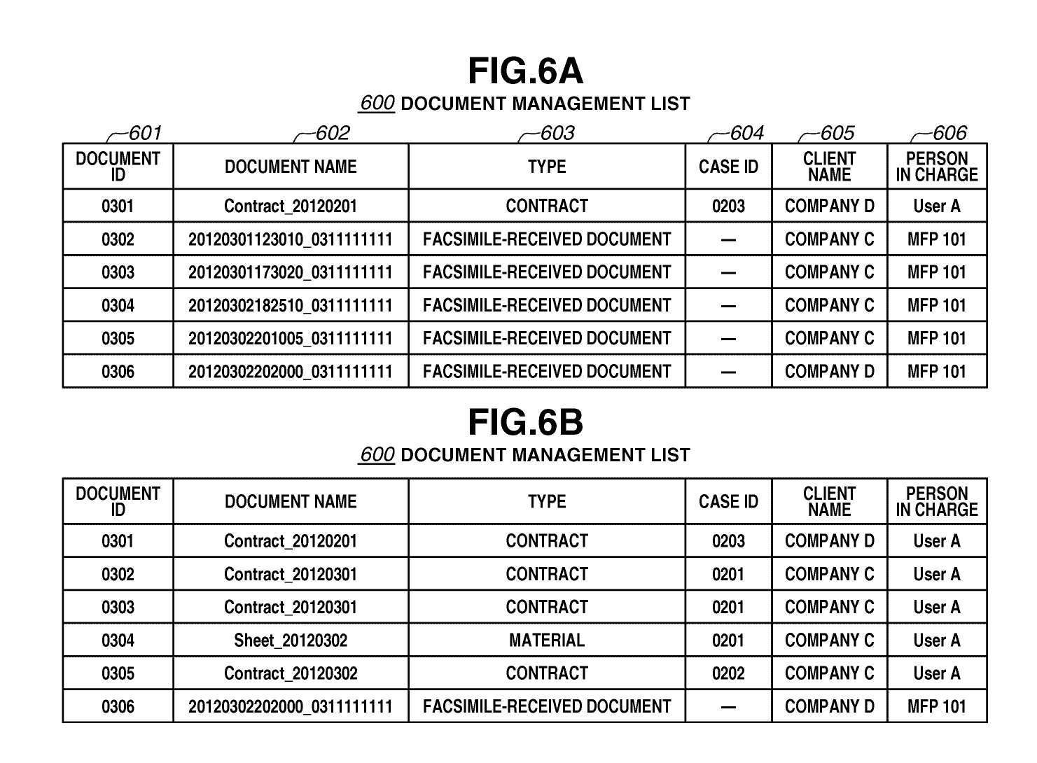

FIGS. 6A and 6B illustrate examples of a document management list 600 stored in the HDD 314 of the case management server 103. Referring to FIG. 6A, a document ID 601 in the document management list 600 is information uniquely indicating each document. A document name 602 is information indicating the name of the document. Upon facsimile-receiving the document, the MFP 101 automatically transfers the document to the case management server 103. The case management server 103 then automatically assigns to the document a document name based on the date and time of facsimile reception and the phone number of the facsimile transmission source. For example, “20120301123010_{—}0311111111” indicates that the document has been transmitted from the phone number 03-1111-1111 and received on Mar. 1, 2012, at 12:30:10.

A type 603 is information indicating the type of the document. Upon facsimile-receiving the document, the MFP 101 automatically transfers the document to the case management server 103. The case management server 103 then automatically assigns to the document the type “facsimile-received document”. A case ID 604 is information indicating the case the document is related to. For example, if the document ID of the document is “0301”, the case ID thereof is “0203”, and it can be identified by referring to FIG. 5 that the document is related to a “lawsuit” case of company D. If a document is facsimile-received by the MFP 101 and automatically transferred to the case management server 103, and the case to which the document is related to is unidentified, the case ID thereof is indicated as “-”.

A client name 605 is information indicating the client of the case the document is related to. If the case ID is assigned to the document, the client name 605 indicates the client of the case identified by the case ID. Further, if the client the document is related to is identified, the information indicating the client is stored in the client name 605 even when the case the document is related to is unidentified (i.e., the case ID is not assigned thereto).

A person in charge 606 is information indicating the person in charge of the case the document is related to. If the case ID is assigned to the document, the person in charge 606 indicates the person in charge of the case identified by the case ID. Further, if the document has been transferred from the MFP 101, and the case the document is related to is unidentified (i.e., the case ID is not assigned thereto), the information indicating the MFP 101 is stored in the person in charge 606.

The documents managed in the document management list 600 are not limited to the documents that have been facsimile-received by the MFP 101. For example, the image data generated by the scanner 222 in the MFP 101 reading the document is managed in the document management list 600. Further, application data generated by a document generation application installed in the PC 102 is managed in the document management list 600.

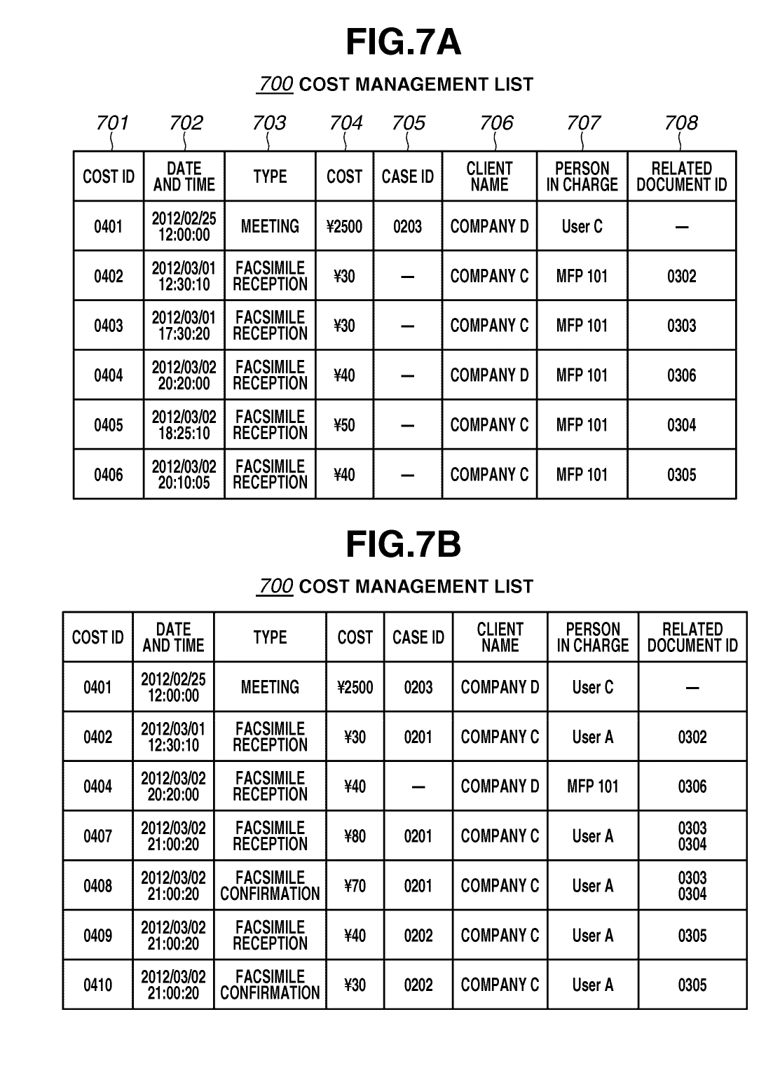

FIGS. 7A and 7B illustrate examples of a cost management list 700 stored in the HDD 314 of the case management server 103. Referring to FIG. 7A, a cost ID 701 in the cost management list 700 is information uniquely indicating the respective costs. Date and time 702 indicate the date and time the cost is incurred. A type 703 is information indicating the type of the cost (i.e., the content of the work which has caused the cost).

A cost 704 is information indicating a charged amount of the cost. A case ID 705 is information indicating the case the cost is related to. The cost is separately managed for each case according to the case ID 705. For example, if the cost ID 701 is “0401”, the case ID 705 of the cost is “0203”. Referring to FIG. 5, such cost is related to the “lawsuit” case of the company D. If the document is facsimile-received by the MFP 101 and automatically transferred to the case management server 103, and the case to which the document is related is unidentified, the case ID is “-” for the facsimile reception cost thereof.

A client name 706 is the information indicating the client of the case the cost is related to. If the case ID is assigned to the cost, the client of the case identified by the case ID is indicated by the client name 706. Further, if the client the cost is related to is identified, the information indicating the client is stored in the client name 706 even when the case the cost is related to is unidentified (i.e., the case ID is not assigned thereto).

A person in charge 707 is information indicating the person in charge of the case the document is related to. If the case ID is assigned to the cost, the person in charge 707 indicates the person in charge of the case identified by the case ID. Further, if the document has been transferred from the MFP 101, and the case to which the cost is related is unidentified (i.e., the case ID is not assigned thereto), the information indicating the MFP 101 is stored in the person in charge 707.

A related document ID 708 is information indicating the document related to the work in which the cost has been incurred. For example, if the cost ID 701 of the cost is “0402”, the related document ID 708 is “0302”. Referring to FIG. 6, it can be recognized in the document management list 600 that such cost is caused by facsimile-receiving the document managed by the document ID “0302”. Further, if there is no related document such as in the case where the type 703 is a “meeting”, the related document ID 708 becomes “-”.

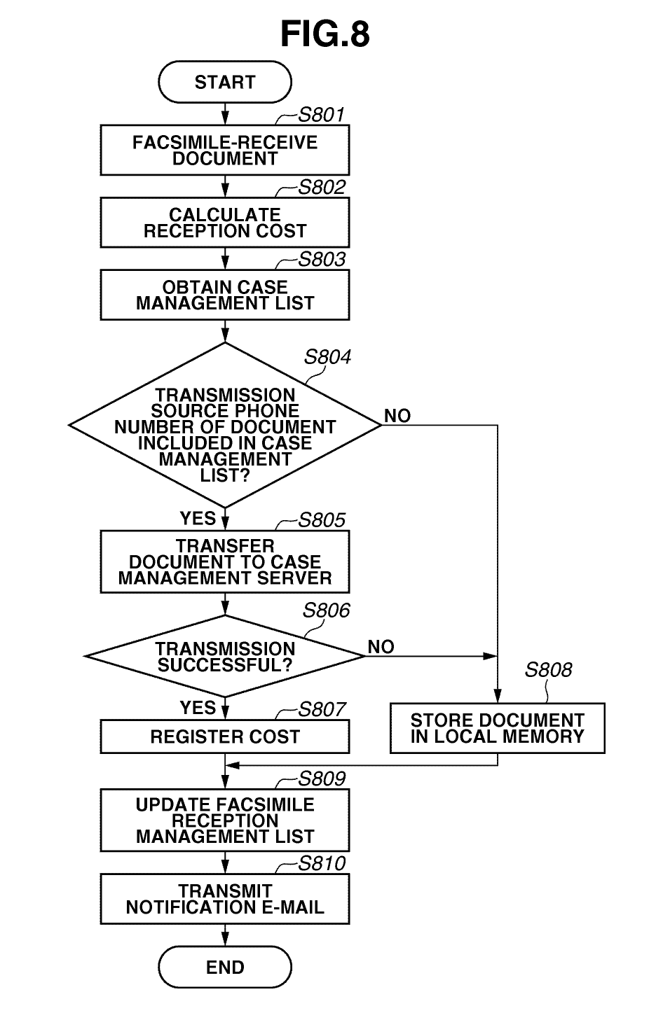

FIG. 8 is a flowchart illustrating the series of processes performed when the MFP 101 facsimile-receives a document. As described above, each of the processes (i.e., steps) in the flowchart illustrated in FIG. 8 is realized by the CPU 211 in the MFP 101 executing the programs stored in the HDD 214.

In step S801, the CPU 211 facsimile-receives the document transmitted via the PSTN 110. In step S802, the CPU 211 calculates the reception cost based on the number of sheets in the facsimile-received document. The CPU 211 can calculate the reception cost by multiplying the number of sheets and the unit cost per sheet, or obtaining the cost corresponding to the number of sheets from a table in which the number of sheets is associated with the cost. However, other methods may also be employed. For example, the CPU 211 may calculate the reception cost according to duration of a call, irrespective of the number of sheets.

In step S803, the CPU 211 requests and obtains from the case management server 103 the case management list 500. In step S804, the CPU 211 determines whether the transmission source phone number of the document which has been facsimile-received in step S801 is included as the phone number 504 in the case management list 500 obtained in step S803.

If the CPU 211 determines that the transmission source phone number is included (YES in step S804), the process proceeds to step S805. On the other hand, if the CPU determines that the transmission source phone number is not included (NO in step S804), the process proceeds to step S808. In step S805, the CPU 211 transfers the document which has been facsimile-received in step S801 to the case management server 103 and stores it in the HDD 314 thereof. In step S806, the CPU 211 determines whether the document has been successfully transferred in step S805. If the CPU 211 determines that the document transfer is successful (YES in step S806), the process proceeds to step S807. If the CPU 211 determines that the document transfer is not successful (i.e., has failed) (NO in step S806), the process proceeds to step S808.

In step S807, the CPU 211 registers in the cost management list 700 the cost incurred in performing facsimile reception. More specifically, the CPU 211 requests the case management server 103 to perform the following process. The CPU 211 requests to add a new record in the cost management list 700. The CPU 211 then requests to store the facsimile reception date and time in the date and time 702 of the new record, “facsimile reception” in the type 703 of the new record, and the reception cost calculated in step S802 in the cost 704 of the new record. Further, the CPU 211 requests to obtain, based on the phone number which has been determined to be the same in step S804, the client name corresponding to the phone number from the case management list 500. The CPU 211 then requests to store the obtained client name in the client name 706 of the new record. The MFP 101 may obtain the client name from the case management list 500, or the case management server 103 which has been notified by the MFP 101 on the transmission source phone number may obtain the client name. Further, if there is only one case in the case management list 500 which has been requested from the client indicated by the client name 706, the CPU 211 requests to store the case ID of the case in the case ID 705 of the new record. In contrast, if there is a plurality of cases which has been requested from the client indicated by the client name 706, the case cannot be identified at this stage. The CPU 211 thus requests to store “-” in the case ID 705 of the new record. Furthermore, if there is only one case which has been requested from the client indicated by the client name 706 in the case management list 500, the CPU 211 requests to store the name of the person in charge of the case in the person in charge 707 of the new record. In contrast, if there is a plurality of cases which has been requested from the client indicated by the client name 706, and the person in charge of each case is the same, the CPU 211 also request to store the name of the person in charge of the case in the person in charge 707 of the new record. If there is a plurality of cases which has been requested from the client indicated by the client name 706, and the person in charge of each case is different, the person in charge cannot be identified at this stage. The CPU 211 thus requests storing “MFP 101” in the person in charge 707 of the new record. Moreover, the CPU 211 requests to store in the related document ID 708 of the new record the document ID issued by the case management server 103 when the CPU 211 has transferred the document thereto in step S805.

On the other hand, in step S808, the CPU 211 stores in the HDD 214 of the MFP 101 the facsimile-received document. It is assumed that the facsimile-received document is converted to a print document format (PDF) file before storing in the case management server 103 or the MFP 101. However, the facsimile-received document may be converted to other formats.

In step S809, the CPU 211 adds a new record to the facsimile reception management list 400, and respectively stores the information in the storage location 402, the reception date and time 403, the reception cost 404, the number of sheets 405, and the transmission source phone number 406.

In step S810, the CPU 211 generates and transmits a notification e-mail for notifying the user of facsimile-receiving the document. The CPU 211 also prompts the user to register the case, the type, the file name, and the cost by transmitting the notification e-mail.

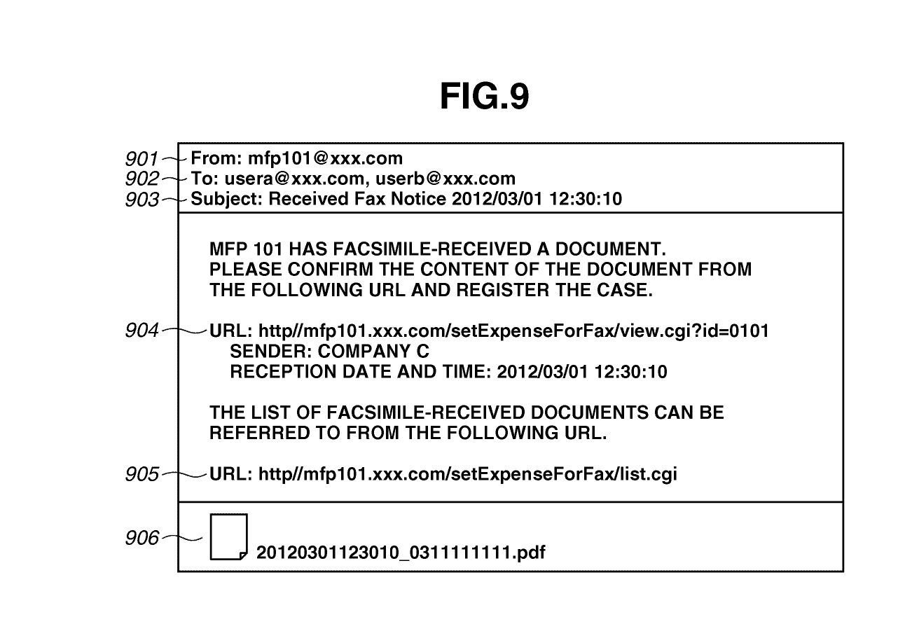

FIG. 9 illustrates an example of the content of the notification e-mail transmitted in step S810. Referring to FIG. 9, an e-mail address of the MFP 101 transmitting the notification e-mail is input after “From” 901. The e-mail address to which the notification e-mail is to be addressed is input after “To” 902. The address to which the notification e-mail is to be transmitted is determined as follows.

If the CPU 211 determines in step S804 in the flowchart illustrated in FIG. 8 that the transmission source phone number of the facsimile-received document is included in the case management list 500, the CPU 211 performs as follows. The CPU 211 obtains from the case management list 500 the person in charge of the case requested from the client corresponding to the phone number, based on the phone number which has been determined to be the same. The CPU 211 then obtains the e-mail address of the obtained person in charge from a table (not illustrated), and writes the obtained e-mail address after “To” 902. If there is a plurality of cases requested from the client corresponding to the same phone number of which the persons in charge are different, the CPU 211 writes the e-mail addresses of each of the persons in charge after “To” 902. On the other hand, if the CPU 211 determines that the transmission source phone number of the facsimile-received document is not included in the case management list 500, the CPU 211 inputs after “To” 902 the e-mail address of an administrator or a mailing list within the office.

A message indicating a facsimile reception notification and the facsimile reception date and time are input as “Subject” 903.

A uniform resource locator (URL) used for confirming the content of the facsimile-received document and registering the case, the type, the file name, and the cost, is input as URL 904. In the example illustrated in FIG. 9, “mfp101.xxx.com” in a character string of the URL 904 indicates the MFP 101, and “setExpenseForFax/view.cgi” indicates displaying a confirmation screen. The confirmation screen is an example of a registration screen, and the URL is an example of specifying information. Further, “id=0101” in a query portion of the URL 904 indicates the facsimile reception managed in the facsimile reception management list 400 according to the reception ID “0101”. URL 905 is used for displaying the list of facsimile-received documents. In the example illustrated in FIG. 9, “mfp101.xxx.com” in the character string of the URL 905 indicates the MFP 101, and “setExpenseForFax/list.cgi” indicates displaying a list screen. An attached file 906 is a thumbnail image of the facsimile-received document in step S801.

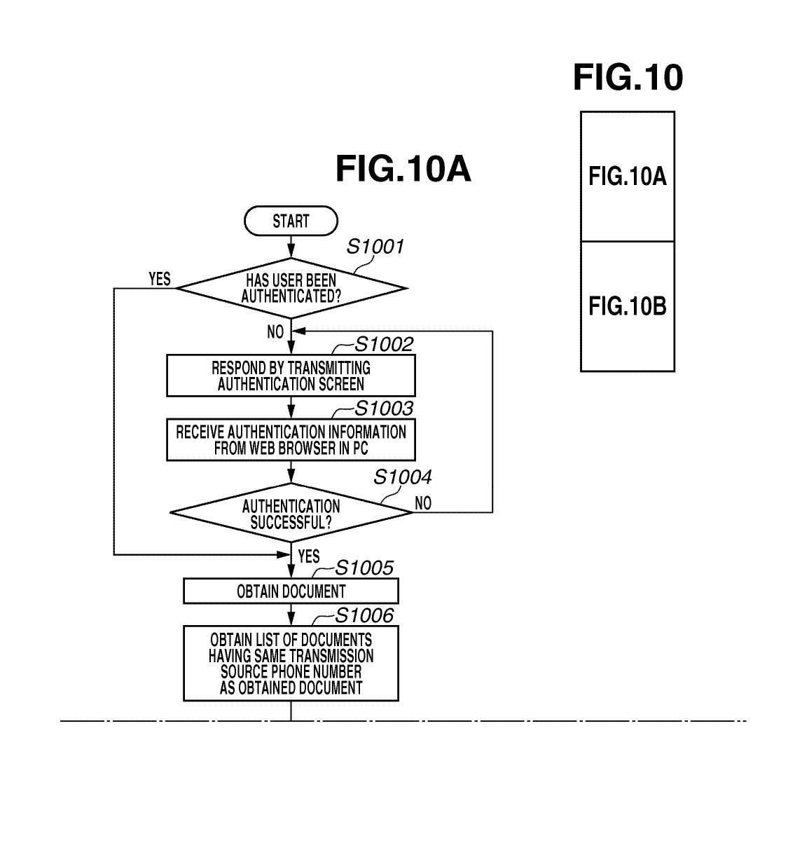

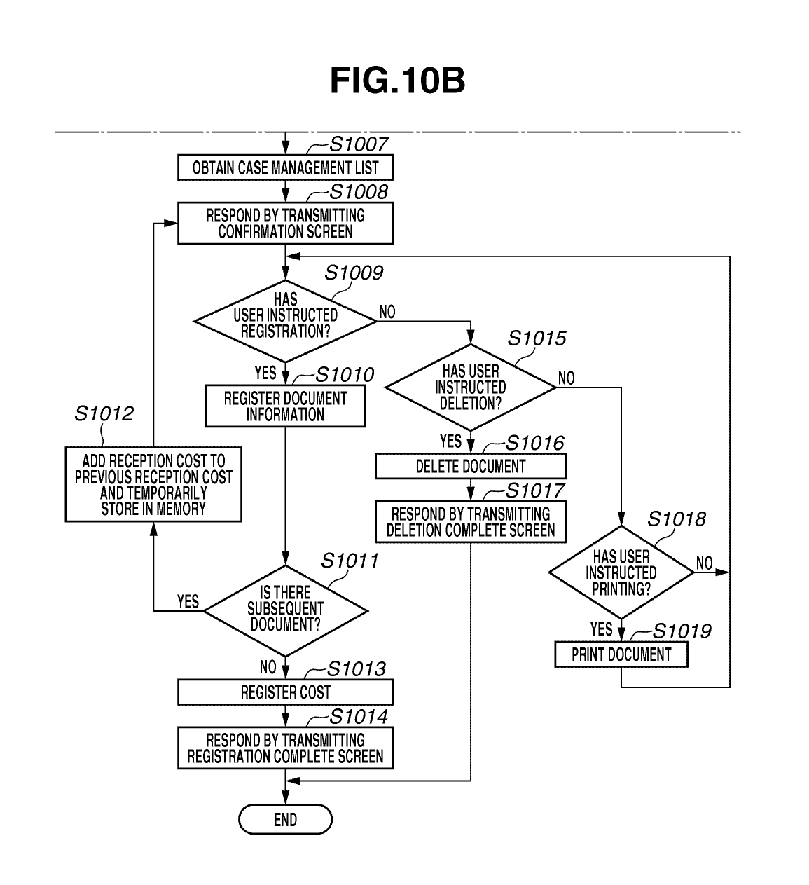

FIG. 10 is a flowchart illustrating the process performed by the MFP 101 when the user confirms the content of the facsimile-received document and registers the case, the type, the file name, and the cost. The process illustrated in the flowchart of FIG. 10 starts when the user of the PC 102 which has received the notification e-mail illustrated in FIG. 9 selects the URL 904.

In step S1001, the CPU 211 in the MFP 101 which has received a request for the confirmation screen from the web browser in the PC 102 determines whether the user of the PC 102 has been authenticated. More specifically, the CPU 211 determines based on session information included in an HTTP header received from the web browser. If the user has been authenticated (YES in step S1001), the process proceeds to step S1005. If the user has not been authenticated (NO in step S1001), the process proceeds to step S1002. In step S1002, the CPU 211 responds by transmitting to the web browser in the PC 102 an authentication screen for receiving authentication information from the user. The authentication screen includes a graphical user interface (GUI) control for receiving the authentication information from the user.

In step S1003, the CPU 211 receives from the web browser in the PC 102 the authentication information input by the user via the authentication screen. In step S1004, the CPU 211 transmits to the case management server 103 the authentication information received in step S1003, and determines whether the authentication performed by the case management server 103 is successful. If the CPU 211 determines that the authentication is successful (YES in step S1004), the process proceeds to step S1005. If the CPU 211 determines that the authentication is not successful (i.e., has failed) (NO in step S1004), the process returns to step S1002.

In step S1005, the CPU 211 obtains the document which has been facsimile-received in step S801 (i.e., performs document obtaining). For example, if the URL 904 is as illustrated in the example of FIG. 9, “id=0101” in the query portion thereof indicates that the reception ID of the record in the facsimile reception management list 400 is “0101”. As a result, the CPU 211 obtains the corresponding information on the storage location 402, i.e., “Server_{—}0302”. The CPU 211 then requests the case management server 103 for the document having the document ID “0302” based on the obtained information. Further, if the query portion of the URL 904 is “id=0102”, the CPU 211 obtains the corresponding information on the storage location 402, i.e., “Local_{—}0001”. The CPU 211 then reads from the HDD 214 of the MFP 101 the document having the document ID “0001” based on the obtained information.

In step S1006, the CPU 211 obtains a list of the facsimile-received documents having the same transmission source phone number 406 as the document obtained in step S1005 (i.e., performs document list obtaining). For example, if the reception ID of the document obtained in step S1005 is “0103” in the facsimile reception management list 400, the CPU 211 obtains the list of received documents having the reception IDs “0101”, “0104”, and “0105”.

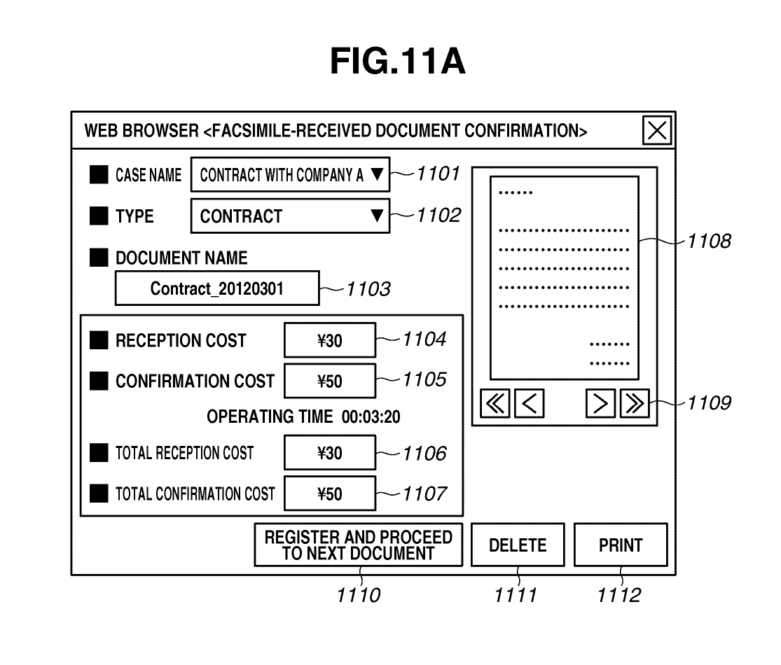

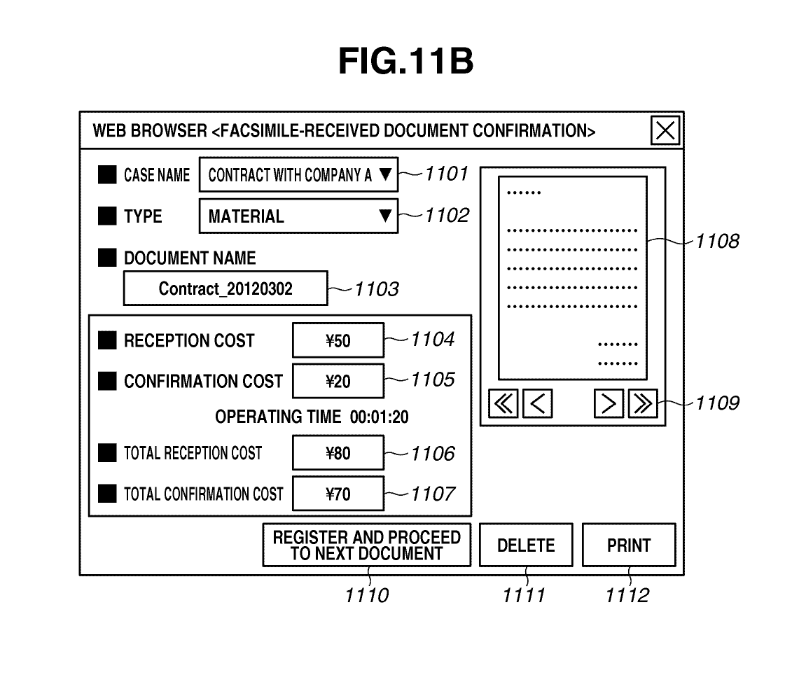

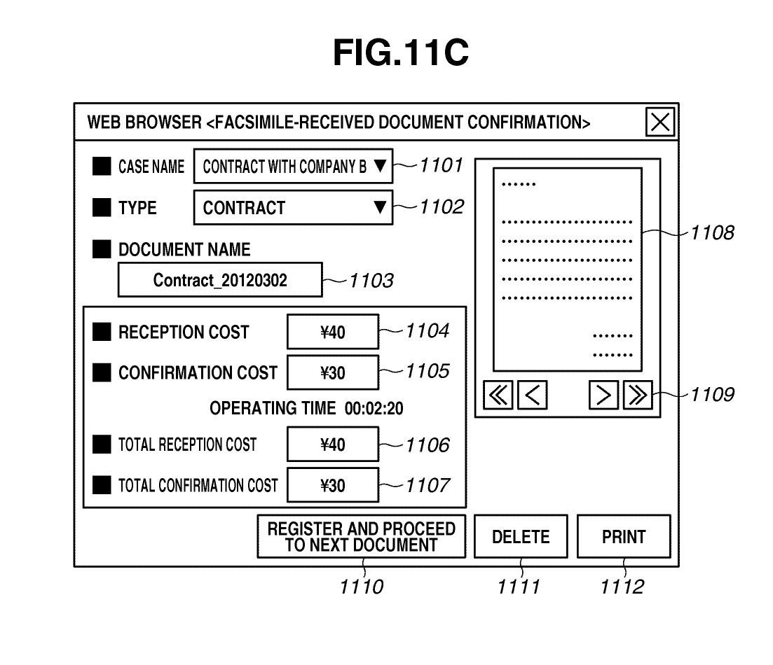

In step S1007, the CPU 211 requests the case management server 103 for and obtains from the case management server 103 the case management list 500. In such a case, the CPU 211 may obtain the entire case management list 500, or only the records of the cases the user authenticated in step S1004 is in charge of. In step S1008, the CPU 211 responds by transmitting to the web browser in the PC 102 the confirmation screens as illustrated in FIGS. 11A, 11B, and 11C. The confirmation screens corresponding to the number of documents included in the list of received documents are displayed by performing the determination process of step S1011 and the process of step S1012 to be described below, and the process of step S1008.

FIGS. 11A, 11B, and 11C illustrate examples of the operation screen displayed on the display device of the PC 102. The web browser in the PC 102 displays the operation screen using HTML and JavaScript® provided by the web server in the MFP 101.

Referring to FIG. 11A, a case name box 1101 indicates the case name of the document obtained in step S1005. For example, in the facsimile reception management list 400 illustrated in FIG. 4, the transmission source phone number 406 of the fax transmission having the reception ID 0103 is “03-1111-1111”. The information stored in the phone number 504 of the records in the case management list 500 illustrated in FIG. 5 is then referred to using the above-described phone number. The cases having the case IDs “0201”, “0202”, and “0204” are thus determined to have the same phone number. If the user authenticated in step S1004 is “User A”, the cases the user is in charge of are “0201” and “0204”. In such a case, “contract with company A” and “contract with company E”, i.e., the case names corresponding to the case IDs “0201” and “0204”, become selectable in a pull-down form in the case name box 1101 in the screens illustrated in FIGS. 11A, 11B, and 11C. If the facsimile-received document is not transferred to the case management server 103, all of the cases which the user authenticated in step S1004 is in charge of among the cases included in the case management list 500 become selectable.

A type box 1102 indicates the type of the document obtained in step S1005. Type candidates predetermined in the case management server 103 or the MFP 101 are selectable in a pull-down form in the type box 1102.

A document name box 1103 indicates the name of the document obtained in step S1005. When the screens illustrated in FIGS. 11A, 11B, and 11C are initially displayed, the document name assigned to the document obtained in step S1005 is displayed. For example, if the document having the document ID 601 “0302” in the document management list 600 is obtained in step S1005, “20120301123010_{—}0311111111” is displayed in the document name box 1103. The user can input an arbitrary character string using the keyboard and the like to change the document name.

A reception cost box 1104 indicates the cost incurred in facsimile-receiving the document obtained in step S1005. For example, the reception cost 404 of “\30” is incurred in the facsimile reception having the reception ID “0103” in the facsimile reception management list 400. As a result, when the screens illustrated in FIGS. 11A, 11B, and 11C are initially displayed, “\30” is displayed in the reception cost box 1104. The user can input an amount of money using the keyboard and the like to change the cost.

A confirmation cost box 1105 indicates the cost of performing facsimile confirmation using the screens illustrated in FIGS. 11A, 11B, and 11C. Elapsed time (i.e., operating time) from when the screens illustrated in FIGS. 11A, 11B, and 11C are displayed is indicated below the confirmation cost box 1105. The confirmation cost displayed in the confirmation cost box 1105 is updated (i.e., added up) as time elapses. Control may be performed so that the user can temporarily stop the operating time.

A total reception cost box 1106 indicates the total reception cost which has been added in step S1012 to be described below. For example, after the document having the reception ID “0103” in the facsimile reception management list 400 is registered, the screen illustrated in FIG. 11B displays the document having the reception ID “0104”. In such a case, “\80” is displayed in the total reception cost box 1106. More specifically, “\80” is the sum of the reception cost “\30” (indicated in the reception cost box 1104 illustrated in FIG. 11A) of the document having the reception ID “0103” and the reception cost “\50” (indicated in the reception cost box 1104 illustrated in FIG. 11B) of the document having the reception ID “0104”. The user then presses a register button 1110, so that the confirmation screen displaying the document having the subsequent reception ID “0105” is displayed as illustrated in FIG. 11C.

A total confirmation cost box 1107 indicates the total confirmation cost obtained by performing addition in step S1012 to be described below.

The user operates on the register button 1110 when registering in the case management server 103 the information input by the user via the screens illustrated in FIGS. 11A, 11B, and 11C and confirming the subsequent document. The user operates on a delete button 1111 when deleting the facsimile-received document without registering the cost. The user operates on a print button 1112 when printing the document obtained in step S1005. The document obtained in step S1005 is preview-displayed in an area 1108. The user uses operation keys 1109 when switching the page of the document to be preview-displayed.

In step S1009 illustrated in the flowchart of FIG. 10, the CPU 211 determines whether the instruction from the user is to “register”. In other words, the CPU 211 determines whether registration is requested from the user. If the user has operated on the register button 1110, the CPU 211 determines that the instruction from the user is to “register” (YES in step S1009). The process then proceeds to step S1010. If the CPU 211 determines that the user has not instructed to “register” (NO in step S1009), the process proceeds to step S1015.

In step S1010, the CPU 211 transmits to the case management server 103 the document information respectively designated in the case name box 1101, the type box 1102, and the document name box 1103 in the screens illustrated in FIGS. 11A, 11B, and 11C. Upon receiving the document information, the case management server 103 stores in the case ID 604 of the record in the document management list 600 the case ID of the case indicated in the case name box 1101. Further, the case management server 103 respectively stores in the type 603 and the document name 602 of the record in the document management list 600 the type indicated in the type box 1102 and the document name indicated in the document name box 1103. Furthermore, the case management server 103 stores in the case ID 705 of the record in the cost management list 700 the case ID of the case indicated in the case name box 1101. Moreover, the case management server 103 stores in the person in charge 707 of the record in the cost management list 700 the person in charge identified by performing authentication in step S1004. If the facsimile-received document is not transferred to the case management server 103 (i.e., stored in the MFP 101), the CPU 211 transfers the document to the case management server 103 in step S1010.

In step S1011, the CPU 211 determines whether there is a subsequent document in the list of the received documents having the same transmission source phone number, obtained in step S1006. If there is a subsequent document (YES in step S1011), the process proceeds to step S1012. If the process has been completed for all documents (NO in step S1011), the process proceeds to step S1013.

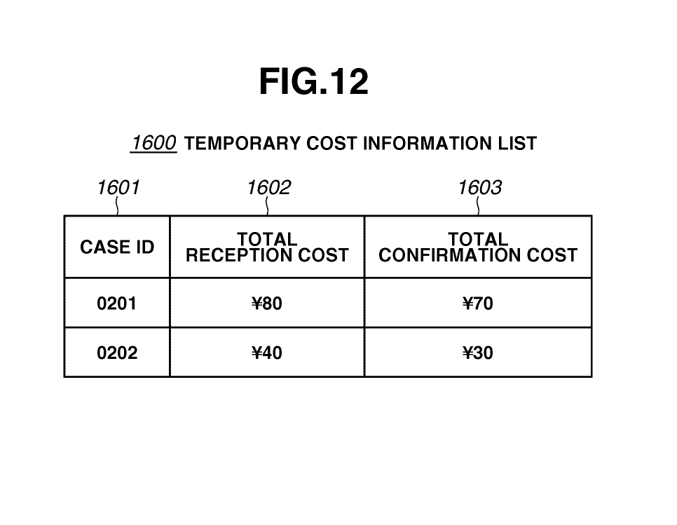

In step S1012, the CPU 211 associates the information indicated in the reception cost box 1104 (i.e., the reception cost information) confirmed by the user in step S1010 with the case ID selected by the user, and temporarily stores the cost. If there is a plurality of reception costs to be associated with the same case ID, the CPU 211 adds the received cost information. The CPU 211 similarly adds the confirmation cost for each case and temporarily stores the cost. FIG. 12 illustrates a temporary cost information list obtained immediately after the user has confirmed the confirmation screen for the documents having the reception IDs “0103”, “0104”, and “0105” in the facsimile reception management list 400. The cost information to be registered may be summed after the user has confirmed a plurality of the facsimile-received documents. The process then returns to step S1008.

In step S1013, the CPU 211 transmits, to the case management server 103, total reception cost 1602 and total confirmation cost 1603 added to the temporary cost information list illustrated in FIG. 12. Upon receiving the information, the case management server 103 deletes the information stored in the cost 704 of the previously generated records of the type “facsimile reception” in the cost management list 700. The case management server 103 then re-generates the records in which the type is “facsimile reception”, and stores the case ID 1601 of the temporary cost information in the case ID 705, and the amount indicated in the total reception cost 1602 in the cost 704. Further, the case management server 103 newly generates a record in which the type is “facsimile confirmation” in the cost management list 700. The case management server 103 then stores the case ID 1601 of the temporary cost information in the case ID 705, and the amount indicated in the total confirmation cost 1603 in the cost 704 of the newly generated record. The case management server 103 also stores in the date and time 702 of the newly generated record, the date and time at which the process of step S1013 has been performed.

In step S1014, the CPU 211 responds by transmitting to the web browser in the PC 102 a registration complete screen indicating that the registration has been completed.

In step S1015, the CPU 211 determines whether the instruction from the user is to “delete”. If the user has operated on the delete button 1111, the CPU 211 determines that the instruction from the user is to “delete” (YES in step S1015). The process then proceeds to step S1016. If the CPU 211 determines that the user has not instructed to “delete” (NO in step S1015), the process proceeds to step S1018.

In step S1016, the CPU 211 deletes the document stored in the case management server 103 or the MFP 101. In such a case, the CPU 211 may delete all records related to the deleted document among the records included in the facsimile reception management list 400, the document management list 600, and the cost management list 700. In step S1017, the CPU 211 responds by transmitting to the web browser in the PC 102 a deletion complete screen indicating that the deletion has been completed.

In step S1018, the CPU 211 determines whether the instruction from the user is to “print”. If the user has operated on the print button 1112, the CPU 211 determines that the instruction from the user is to “print” (YES in step S1018). The process then proceeds to step S1019. If the CPU 211 determines that the user has not instructed to “print” (NO in step S1018), the process returns to step S1009.

In step S1019, the CPU 211 prints using the printer 221 the document obtained in step S1005. The CPU 211 may notify the case management server 103 of the cost of printing, and generate a new record in the cost management list 700.

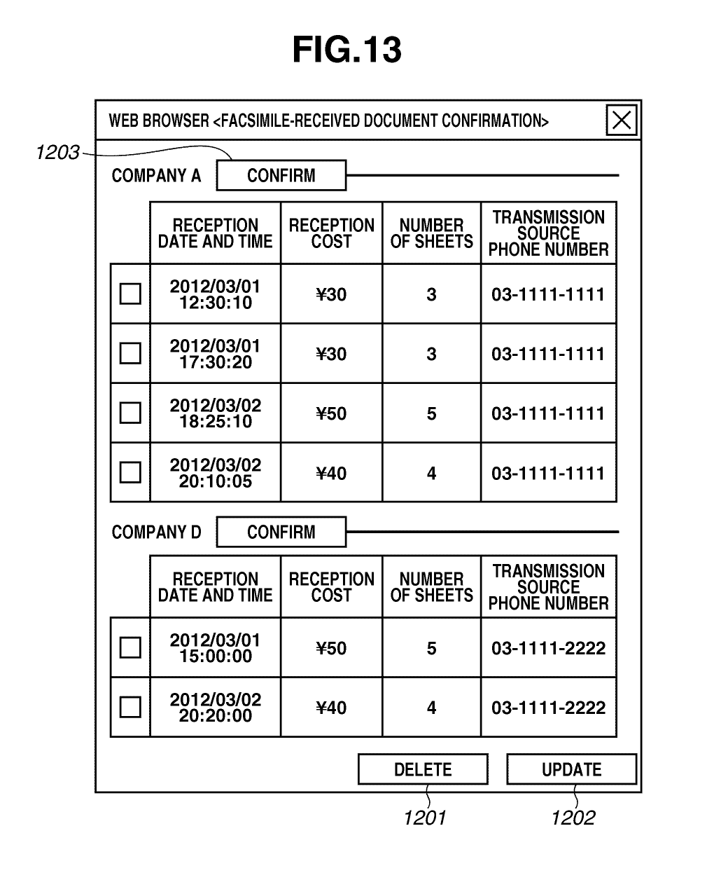

FIG. 13 illustrates an example of the operation screen displayed on the display device of the PC 102. The web browser in the PC 102 displays the screen illustrated in FIG. 13 using HTML and JavaScript provided by the web browser in the MFP 101. When the user of the PC 102 receives the notification e-mail illustrated in FIG. 9 and selects the URL 905, the screen illustrated in FIG. 13 is displayed. It is necessary to perform the authentication process in step S1001 to step S1004 of the flowchart illustrated in FIG. 10 to display the screen illustrated in FIG. 13.

Referring to FIG. 13, a list of the facsimile reception managed in the facsimile reception management list 400 is displayed in the screen. If the user selects an arbitrary facsimile reception and operates on a delete button 1201, the facsimile-received document is deleted. Further, if the user operates on an update button 1202, the latest facsimile reception management list 400 is read, and the screen illustrated in FIG. 13 is updated. A link (i.e., the URL 904) for displaying the screens illustrated in FIGS. 11A, 11B, and 11C is embedded in each row, and the user can jump from the screen illustrated in FIG. 13 to the screens illustrated in FIGS. 11A, 11B, and 11C. The CPU 211 extracts, from the facsimile reception management list 400, only the records related to the user authenticated in step S1004. The CPU 211 extracts the records based on the transmission source phone number 406 in the facsimile reception management list 400 and the person in charge 505 in the case management list 500. The CPU 211 may then cause the extracted records to be displayed in the screen illustrated in FIG. 13. Further, the CPU 211 obtains the client name from the case management list 500 based on the transmission source phone number, and displays the list by groups. Furthermore, if the user operates on a confirm button 1203, the screen jumps to the screens illustrated in FIGS. 11A, 11B, and 11C with respect to a first document in each group.

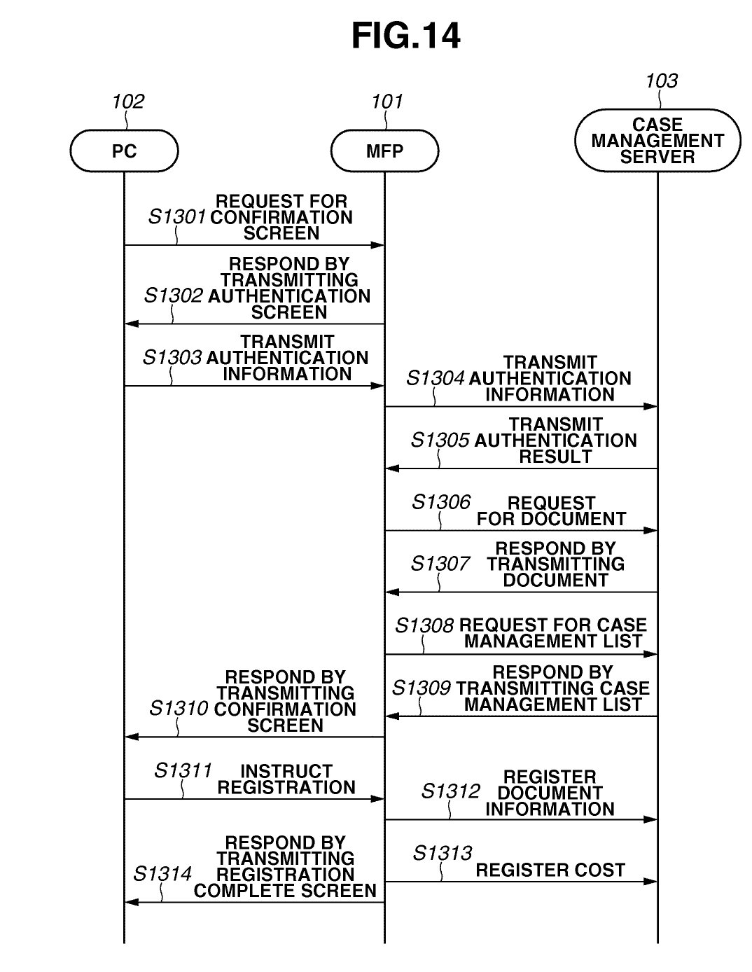

The entire process performed in the case where the user registers the case, the type, the file name, and the cost using the URL 904 illustrated in FIG. 9 when each of the management lists is in the state respectively illustrated in FIGS. 4, 5, 6A, and 7A will be described below. The process will be described with reference to a sequence diagram illustrated in FIG. 14.

In step S1301, the web browser in the PC 102 requests the web server in the MFP 101 for the confirmation screen, using the URL 904 illustrated in FIG. 9. The request is an example of a screen display request. Upon receiving the request, the MFP 101 determines that the user of the PC 102 has not been authenticated. In step S1302, the MFP 101 responds by transmitting the authentication screen (i.e., performs the process corresponding to step S1002 illustrated in FIG. 10). In step S1303, the PC 102 transmits to the MFP 101 the authentication information input by the user via the authentication screen displayed on the web browser in the PC 102 (i.e., performs the process corresponding to step S1003).

In step S1304, the MFP 101 transmits to the case management server 103 the authentication information received from the PC 102. In step S1305, the case management server 103 performs authentication based on the received authentication information, and transmits to the MFP 101 an authentication result (that the authentication is successful) (i.e., performs the process corresponding to step S1004).

The MFP 101 identifies, based on the query portion “id=0101” in the URL 904, the record in the facsimile reception management list 400 having the received ID 401 “0101”. The MFP 101 then obtains the information “Server_{—}0302” on the storage location 402 of the identified record. The information indicates that the document to which the document ID “0302” is assigned is stored in the case management server 103. In step S1306, the MFP 101 thus requests the case management server 103 for the document having the document ID “0302” (i.e., performs the process corresponding to step S1005).

In step S1307, the case management server 103 responds by transmitting to the MFP 101 the designated document. In step S1308, the MFP 101 requests the case management server 103 for the case management list 500 (i.e., performs the process corresponding to step S1007). In step S1309, the case management server 103 transmits the case management list 500 to the MFP 101.

In step S1310, the web server in the MFP 101 responds by transmitting the confirmation screen to the web browser in the PC 102 (i.e., performs the process corresponding to step S1008). The web browser in the PC 102 then displays the confirmation screens illustrated in FIGS. 11A, 11B, and 11C. The user operates on the register button 1110 in the state where the contents illustrated in FIGS. 11A, 11B, and 11C have been input. In step S1311, the web browser in the PC 102 then transmits to the web server in the MFP 101 the registration instruction and the input contents. In step S1312, upon receiving the instruction and the contents, the MFP 101 registers the document information in the case management server 103 (i.e., performs the process corresponding to step S1010). In step S1313, the MFP 101 registers the cost in the case management server 103 (i.e., performs the process corresponding to step S1013). In step S1314, the web server in the MFP 101 responds by transmitting the registration complete screen to the web browser in the PC 102.

By performing the above-described process, the document management list 600 illustrated in FIG. 6A and the cost management list 700 illustrated in FIG. 7A are respectively changed to the states illustrated in FIGS. 6B and 7B. More specifically, the document name 602 of the record having the document ID 601 “0302” in the document management list 600 is changed from “20120301123010_{—}0311111111” to “Contract_{—}20120301”. Further, the type 603 of the record is changed from “facsimile-received document” to “contract”. Furthermore, the case ID 604 of the record is changed from “-” to “0201”. Moreover, the person in charge 606 of the record is changed from “MFP 101” to “User A”. The document name 602 of the record having the document ID 601 “0303” in the document management list 600 is changed from “20120301173020_{—}0311111111” to “Contract_{—}20120301”. Further, the type 603 of the record is changed from “facsimile-received document” to “contract”. Furthermore, the case ID 604 of the record is changed from “-” to “0201”. Moreover, the person in charge 606 of the record is changed from “MFP 101” to “User A”. The document name 602 of the record having the document ID 601 “0304” in the document management list 600 is changed from “20120302182510_{—}0311111111” to “Sheet_{—}20120302”. Further, the type 603 of the record is changed from “facsimile-received document” to “material”. Furthermore, the case ID 604 of the record is changed from “-” to “0201”. Moreover, the person in charge 606 of the record is changed from “MFP 101” to “User A”. The document name 602 of the record having the document ID 601 “0305” in the document management list 600 is changed from “20120302201005_{—}0311111111” to “Contract_{—}20120302”. Further, the type 603 of the record is changed from “facsimile-received document” to “contract”. Furthermore, the case ID 604 of the record is changed from “-” to “0202”. Moreover, the person in charge 606 of the record is changed from “MFP 101” to “User A”.

The case ID 705 of the record having the cost ID “0402” in the cost management list 700 is changed from “-” to “0201”. Further, the person in charge 707 of the record is changed from “MFP 101” to “User A”. Furthermore, the records having the cost IDs 701 “0403”, “0405”, and “0406” are deleted, and the records having the cost IDs “0407” and “0409” are newly generated. “0201” is stored in the case ID 705 of the newly generated record “0407”, and “\80”, i.e., the amount indicated as the total reception cost 1602 is stored in the cost 704.

Moreover, the records having the cost IDs “0408” and “0410” are newly generated in the cost management list 700. The date and time the registration process has been performed are stored in the date and time 702 of the newly generated record “0408”. Further, “facsimile confirmation” is stored in the type 703 of the newly generated record “0408”. Furthermore, “\70”, i.e., the amount of the total confirmation cost 1603, is stored in the cost 704 of the newly generated record “0408”, and “0201” is stored in the case ID 705 thereof. Moreover, “company C” is stored in the client name 706, “User A” is stored in the person in charge 707, and “0303” and “0304” are stored in the “related document ID” 708 of the newly generated record “0408”.

As described above, according to the first exemplary embodiment, the MFP 101 automatically transfers to the case management server 103 the facsimile-received documents which the transmission source phone numbers thereof are included in the case management list 500. The MFP 101 identifies the client from the transmission source phone number of the facsimile-received document, and identifies the user corresponding to the identified client. The MFP 101 then transmits the notification e-mail to the identified user. The user receiving the notification e-mail determines an order the documents are to be confirmed for each transmission source phone number and screen transition illustrated in FIGS. 11A, 11B, and 11C. The user can thus easily perform confirmation of the content of the facsimile-received document and registration of the case, the type, the file name and the cost thereof. Further, the MFP 101 adds consecutive cost information based on the case information selected by the user, and collectively registers the cost information after all documents have been confirmed. The cost charging operation can thus be easily performed.

According to the present exemplary embodiment, registration of the cost information on the facsimile-received documents has been described as an example. However, the present invention may also be applied registration of the cost information on the facsimile-transmitted documents.

In other words, the MFP 101 automatically transfers to the case management server 103 the facsimile-transmitted documents of which transmission destination phone numbers are included in the case management list 500. The MFP 101 identifies the client from the transmission destination phone number of the facsimile-transmitted document, and identifies the user corresponding to the identified client. The MFP 101 then transmits the notification e-mail to the identified user. The user receiving the notification e-mail determines the order the documents are to be confirmed for each transmission destination phone number and the screen transition illustrated in FIGS. 11A, 11B, and 11C. The user can thus easily perform confirmation of the content of the facsimile-transmitted document and registration of the case, the type, the file name and the cost thereof. Further, the MFP 101 adds the consecutive cost information based on the case information selected by the user, and collectively registers the cost information after all documents have been confirmed. The cost charging operation can thus be easily performed.

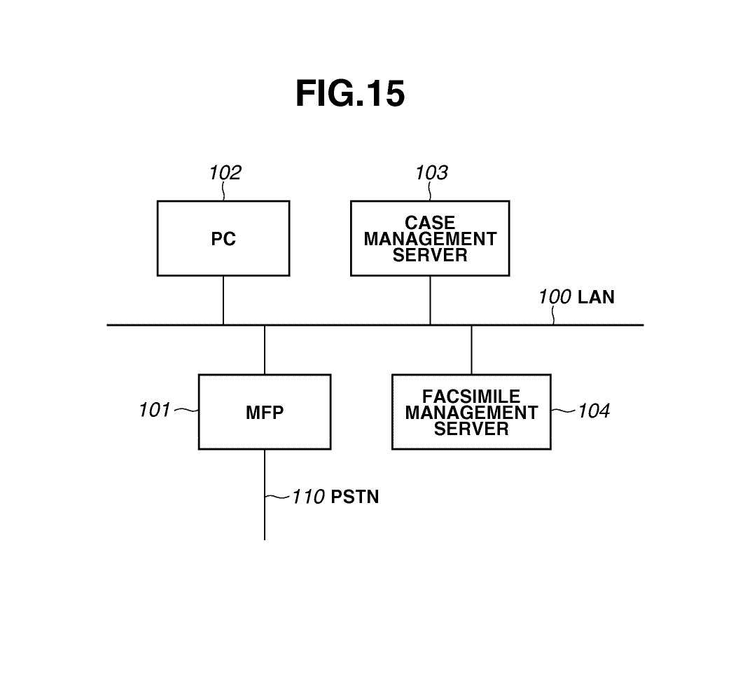

The second exemplary embodiment will be described below. According to the second exemplary embodiment, there is a facsimile management server 104 separate from the MFP 101 that performs facsimile reception. The facsimile management server 104 manages the facsimile reception, transfers the documents to the case management server 103, provides the screens to the PC 102, and registers in the case management server 103 the document information and the cost. The facsimile management server 104 is an example of a facsimile management apparatus. FIG. 15 illustrates an example of the system configuration of the image processing system which is different from the image processing system illustrated in FIG. 1 in that the facsimile management server 104 is provided on the LAN 100. The MFP 101 transfers all facsimile-received documents to the facsimile management server 104. The hardware configuration of the facsimile management server 104 is the same as that of the case management server 103 illustrated in FIG. 3. The CPU in the facsimile management server 104 performs the processes based on the programs stored in the HDD and the like in the facsimile management server 104. The functions of the facsimile management server 104 and the processes performed by the facsimile management server 104 illustrated in the flowchart to be described below are thus realized.

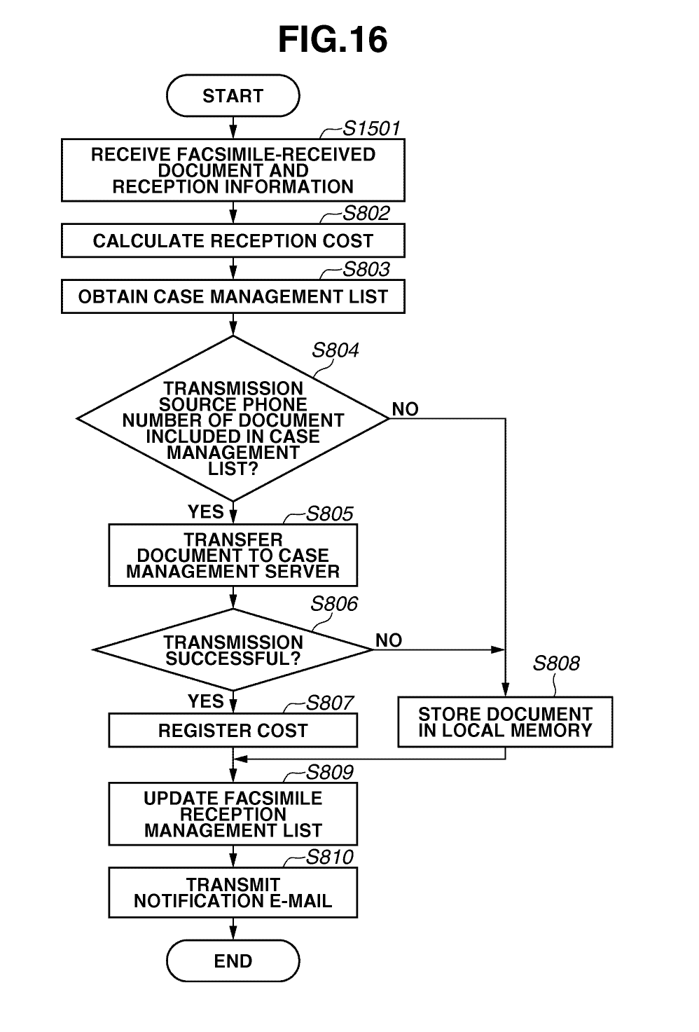

FIG. 16 is a flowchart illustrating the series of processes performed by the facsimile management server 104 when the MFP 101 has performed facsimile reception. The flowchart illustrated in FIG. 16 corresponds to the flowchart illustrated in FIG. 8. As described above, each of the processes (i.e., steps) in the flowchart illustrated in FIG. 16 is realized by the CPU 311 in the facsimile management server 104 executing the programs stored in the HDD 314.

The flowchart illustrated in FIG. 16 is different from the flowchart illustrated in FIG. 8 in that the CPU 311 performs the process of step S1501 instead of step S801.

In step S1501, the CPU 311 receives, from the MFP 101, the document which has been facsimile-received by the MFP 101 and reception information (i.e., the information managed in the facsimile reception management list 400, such as the number of received sheets and the transmission source phone number). The processes from step S802 to step S810 are similar to those illustrated in FIG. 8, and are performed by the facsimile management server 104 instead of the MFP 101. Further, according to the second exemplary embodiment, when the user confirms the contents of the facsimile-received document and records the case, the type, the file name, and the cost, the facsimile management server 104 performs the processes similar to those described with reference to FIG. 10 instead of the MFP 101. However, when the document is to be printed in step S1019, the facsimile management server 104 transmits the document to the MFP 101, and causes the printer 221 in the MFP 101 to print the document.

As described above, according to the second exemplary embodiment, the facsimile management server 104 automatically transfers to the case management server 103 the documents facsimile-received by the MFP 101 which the transmission source phone numbers thereof are included in the case management list 500. The facsimile management server 104 identifies the client from the transmission source phone number of the facsimile-received document, and identifies the user corresponding to the identified client. The facsimile management server 104 then transmits the notification e-mail to the identified user. The user receiving the notification e-mail determines the order the documents are to be confirmed for each transmission source phone number and the screen transition illustrated in FIGS. 11A, 11B, and 11C. The user can thus easily perform confirmation of the content of the facsimile-received document and registration of the case, the type, the file name and the cost thereof. Further, the facsimile management server 104 adds the consecutive cost information based on the case information selected by the user, and collectively registers the cost information after all documents have been confirmed. The cost charging operation can thus be easily performed.

According to the present exemplary embodiment, registration of the cost information on the facsimile-received documents has been described as an example. However, the present invention may also be applied to registration of the cost information on the facsimile-transmitted documents.

Further, according to the first and second exemplary embodiments, the client may set a contract with the office over a specific period (e.g., one year) for a fixed fee, instead of being charged for each work. In such a case, a flag indicating “not register cost” may be set to the cases in the case management list 500 and managed. The MFP 101 or the facsimile management server 104 thus does not register in the case management server 103 the cost for the cases to which the flag has been set.

Embodiments of the present invention can also be realized by a computer of a system or apparatus that reads out and executes computer executable instructions recorded on a storage medium (e.g., computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a CPU, a micro processing unit (MPU), or other circuitry, and may include a network of separate computers or separate computer processors. The computer executable instructions may be provided to the computer, for example, from a network or the storage medium. The storage medium may include, for example, one or more of a HD, a RAM, a ROM, a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and function.

This application claims priority from Japanese Patent Application No. 2012-280169 filed Dec. 21, 2012, which is hereby incorporated by reference herein in its entirety.

What is claimed is:

1. An information processing system comprising:
a storing unit configured to store a plurality of received documents;
a selection unit configured to select from among the plurality of documents stored in the storing unit a plurality of documents transmitted from the same transmitting source as an identified document; and
a providing unit configured to provide a screen which allows information on a plurality of documents selected by the selection unit to be collectively registered.

2. The information processing system according to claim 1, wherein the storing unit stores a plurality of facsimile-received documents, and
wherein the selection unit selects from among the plurality of documents stored in the storing unit a plurality of facsimile-transmitted documents transmitted from the same transmission source phone number as the identified document.

3. The information processing system according to claim 1, wherein the providing unit provides, in the case where the selection unit has selected a first document and a second document, a screen for inputting information on the first document, including operation keys to be used in displaying a screen for inputting information on the second document.

4. The information processing system according to claim 1, wherein the information is information indicating cost.

5. The information processing system according to claim 4, wherein the providing unit provides, in the case where the selection unit has selected a first document and a second document, a screen including a sum of cost with respect to the first document and cost with respect to the second document.

6. The information processing system according to claim 1, wherein the user identifies a document by accessing a predetermined URL.

7. The information processing system according to claim 1, further comprising a transmission unit for transmitting an e-mail in which the predetermined URL is written.

8. An information processing method comprising:
storing a plurality of received documents; selecting, from among the stored plurality of received documents, a plurality of documents transmitted from the same transmitting source as an identified document; and
providing a screen which allows information on the selected plurality of documents to be collectively registered.

9. The information processing method according to claim 8, wherein the selecting is, from among the stored plurality of documents, a plurality of facsimile-transmitted documents transmitted from the same transmission source phone number as the identified document.

10. The information processing method according to claim 8, wherein the providing is, in the case where a first document and a second document have been selected, a screen for inputting information on the first document, including operation keys to be used in displaying a screen for inputting information on the second document.

11. The information processing method according to claim 8, wherein the information is information indicating cost.

12. The information processing method according to claim 11, wherein the providing is, in the case where a first document and a second document have been selected, a screen including a sum of cost with respect to the first document and cost with respect to the second document.

13. The information processing method according to claim 8, wherein the user identifies a document by accessing a predetermined URL.

14. The information processing method according to claim 8, further comprising transmitting an e-mail in which the predetermined URL is written.

15. A non-transitory computer-readable medium storing computer executable instructions for causing a computer to execute the method defined by claim 8.
